(19) United States
(12) Patent Application Publication
(10) Pub. No.: US 2014/0345436 A1
(43) Pub. Date: Nov. 27, 2014

(54) SAW GUIDE FOR A HAND HELD POWER SAW

(71) Applicant: Karl BEHRISCH, Fort McMurray (CA)

(72) Inventor: Karl BEHRISCH, Fort McMurray (CA)

(21) Appl. No.: 14/283,695

(22) Filed: May 21, 2014

Related U.S. Application Data
(60) Provisional application No. 61/826,249, filed on May 22, 2013.

(51) Int. Cl. B27B 9/04; B27G 19/04; B23D 45/16; B23Q 9/00

(52) U.S. Cl. CPC B27B 9/04; B23Q 9/0014; B27G 19/04; B23D 45/16
USPC 83/745; 30/374

(57) ABSTRACT

A saw guide for a hand held power saw with a rotating circular blade includes a plate (sometimes referred to as a skate plate) having a first face and a second face, peripheral edges and an elongated slot positioned adjacent one of the peripheral edges. The slot extends through the plate from the first face to the second face. A saw receiving seat is positioned on the first face adapted to receive the hand held power saw with the rotating circular blade of the hand held power saw extending down through the elongated slot. Protruding attachment tabs are positioned along the peripheral edges of the plate having openings to facilitate fasteners securing the hand held power saw on the saw receiving seat. Rail guides depend from the second face of the plate. The rail guides defining a guide channel with opposing sidewalls that are parallel to the elongated slot and parallel to each other.

### FIELD

There is described a saw guide which is used with a rail system for the purpose of guiding a hand held power saw with a rotating circular blade.

### BACKGROUND

U.S. Pat. No. 4,356,748 (Tilton) entitled “Saw Guide” discloses a saw guide for a hand held circular power saw. The saw guide system consists of two components: a saw guide that attaches to the hand held circular power saw and a rail along which the saw guide runs. Subsequent to the Tilton reference, there have been a number of improved guide and rail systems proposed, such as United States Patent publications 20090308218 (Raff et al); 20110271814 (Di Nicolontonio et al); and 20120285305 (Jablonsky). There will be described a saw guide that can be used either with a simplified rail system or with many of the rail systems disclosed in the prior art.

### SUMMARY

There is provided a saw guide for a hand held power saw with a rotating circular blade. The saw guide has a guide body which is a plate (sometimes referred to as a skate plate) having a first face and a second face, peripheral edges and an elongated slot positioned adjacent one of the peripheral edges. The slot extends through the plate from the first face to the second face. A saw receiving seat is positioned on the first face adapted to receive the hand held power saw with the rotating circular blade of the hand held power saw extending down through the elongated slot. Protruding attachment tabs are positioned along the peripheral edges of the plate having openings to facilitate fasteners securing the hand held power saw on the saw receiving seat. Rail guides depend from the second face of the plate. The rail guides defining a guide channel with opposing sidewalls that are parallel to the elongated slot and parallel to each other.

The saw guide described above in intended for use with a rail positional within the guide channel. The rail is first fixed to a substrate to be cut by the saw. The guide body then travels axially along the rail with lateral movement of the guide body constrained by the guides which depend from the second face of the plate and define the guide channel.

The saw guide, as described above, provides a number of distinct advantages over known prior art saw guide systems. One advantage is the near universal accommodation of most portable circular saws presently on the market. Another advantage is the relative ease of use in terms of attachment to and detachment from a portable saw. A further important advantage is that a user can make or acquire a guide bar without necessarily purchasing a more costly system. All that is required is that the rail selected be straight and be sized to fit within the guide channel defined by the rail guides.

There is also described a rail positioning body that can be used with the guide body to make angled cuts. The rail positioning body includes a plate having an upper surface and a lower surface. The plate is first attached to a substrate being cut by a saw. The plate has an upstanding axle. When used with a rail having a bottom surface with an axle receiving opening, the rail can be made to pivot about the axle to assume a selected pivotal position. The rail is then secured in position and the guide body travels axially along the rail with lateral movement of the guide body constrained by the guides which depend from the second face of the plate and define the guide channel.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of a saw guide.

FIG. 2 is a bottom plan view of a saw guide.

FIG. 3 is a front elevation view of a saw guide.

FIG. 4 is a right side elevation view of a saw guide.

FIG. 5 is a left side elevation view of a saw guide.

FIG. 6 is a perspective view of a saw guide.

FIG. 7 is a top plan view of a saw guide attached to a saw.

FIG. 8 is a bottom plan view of a saw guide attached to a saw.

FIG. 9 is a hack elevation view of a saw guide attached to a saw.

FIG. 10 is a left side elevation view of a saw guide attached to a saw.

FIG. 11 is a perspective view of a saw guide attached to a saw.

FIG. 12 is a bottom plan view of a saw guide attached to a saw with an associated rail positioning guide.

FIG. 13 is a front elevation view of a saw guide attached to a saw with an associated rail positioning guide.

FIG. 14 is a left side elevation view of a saw guide attached to a saw with an associated rail positioning guide.

FIG. 15 is a perspective view of a saw guide attached to a saw with an associated rail positioning guide.

FIG. 16 is an exploded perspective view of a saw guide attached to a saw with an associated rail positioning guide.

### DETAILED DESCRIPTION

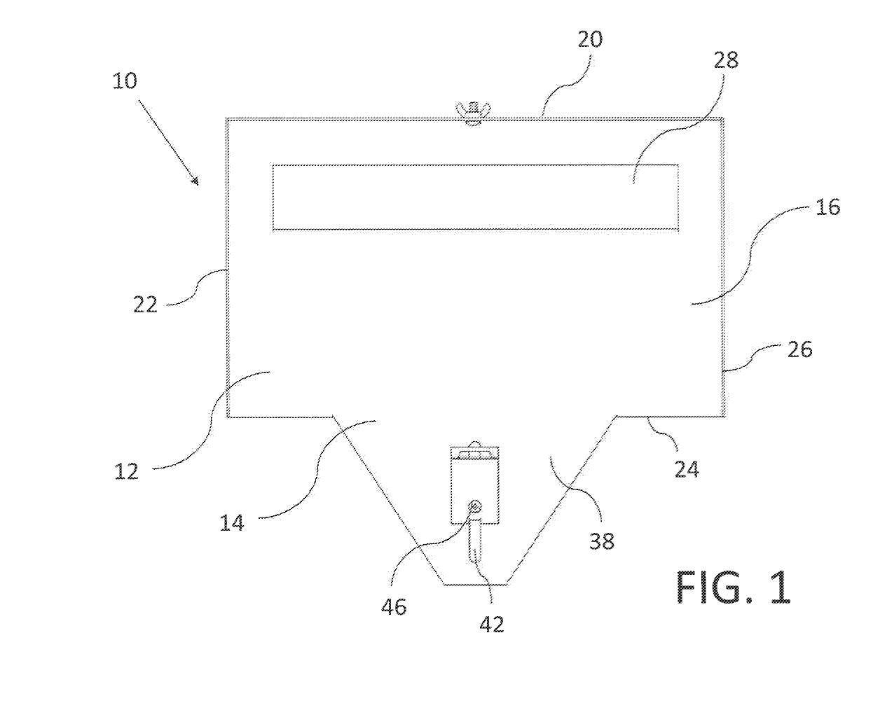

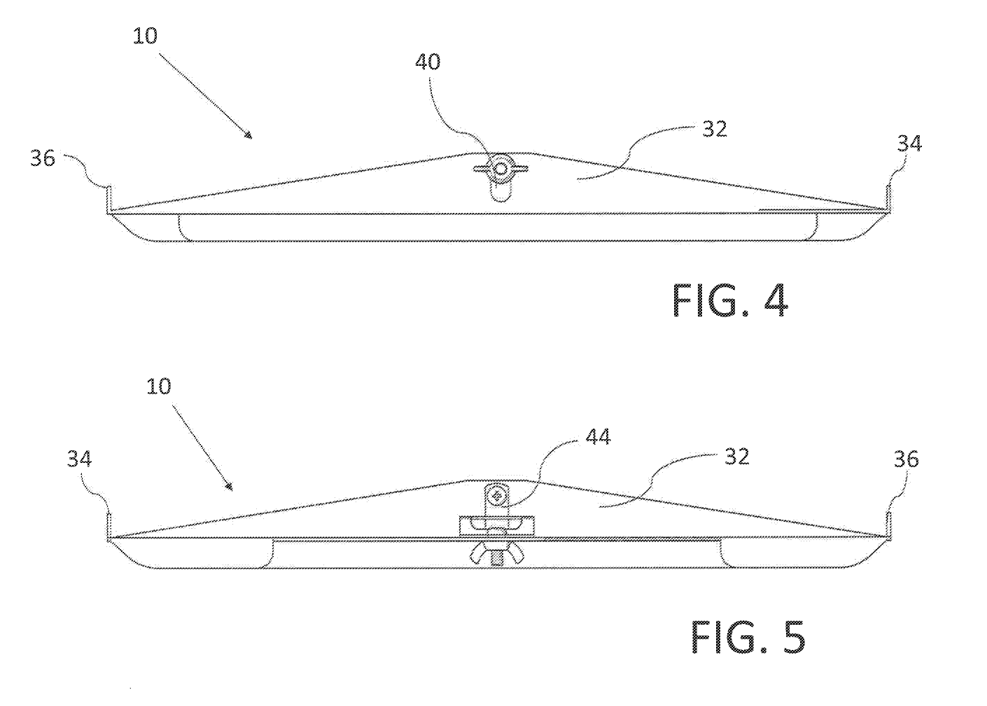

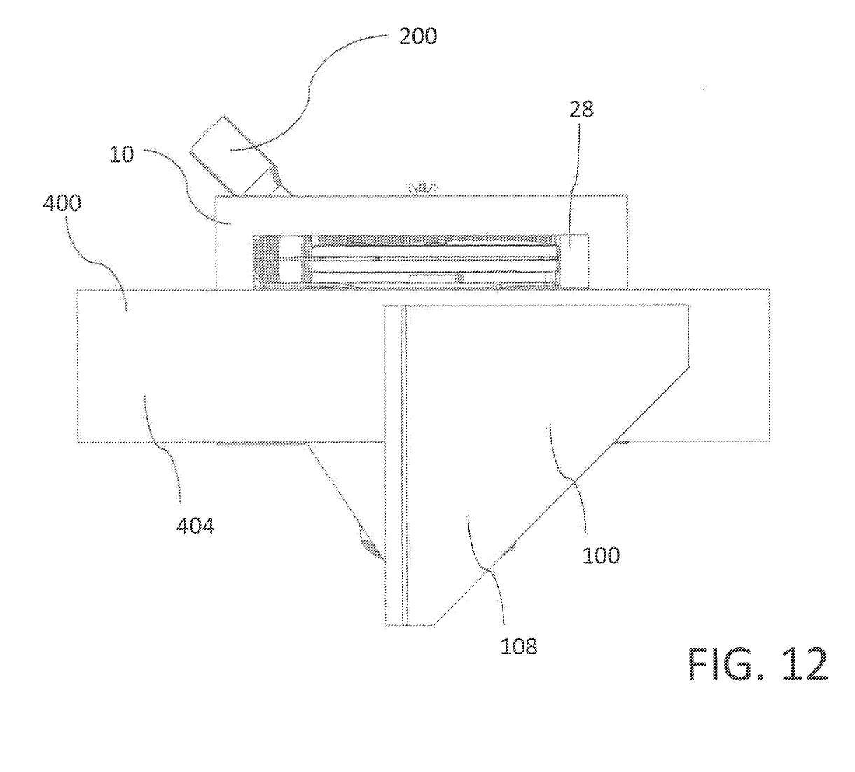

A saw guide generally identified by reference numeral 10, will now be described with reference to FIG. 1 through 11. An associated rail positioning guide, generally identified by reference numeral 100, developed for use with saw guide 10 will then be described with reference to FIG. 12 through 16.

### Structure and Relationship of Parts:

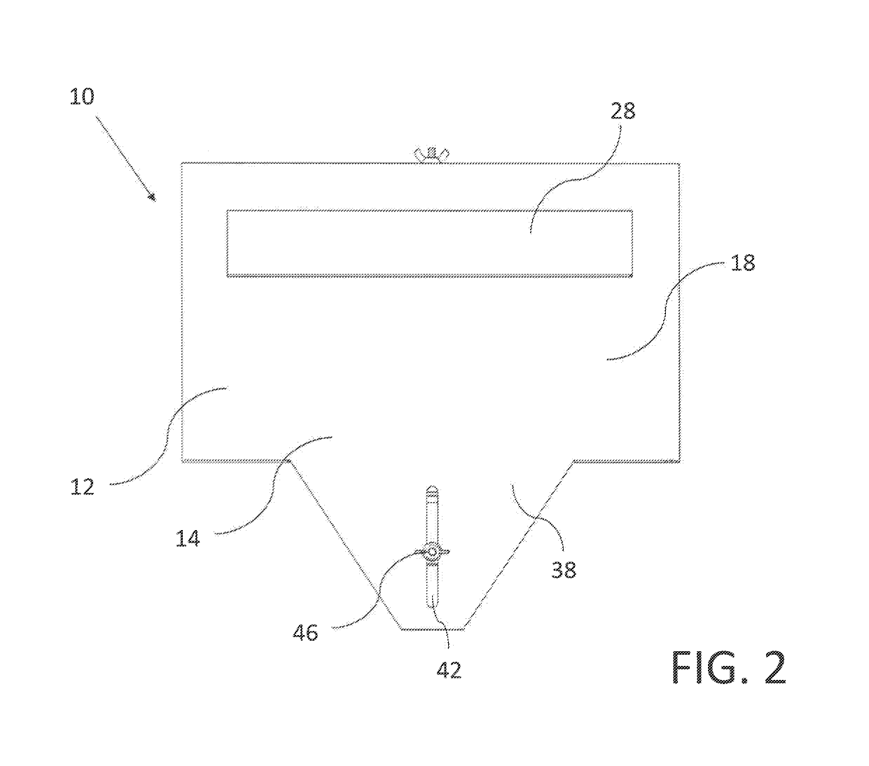

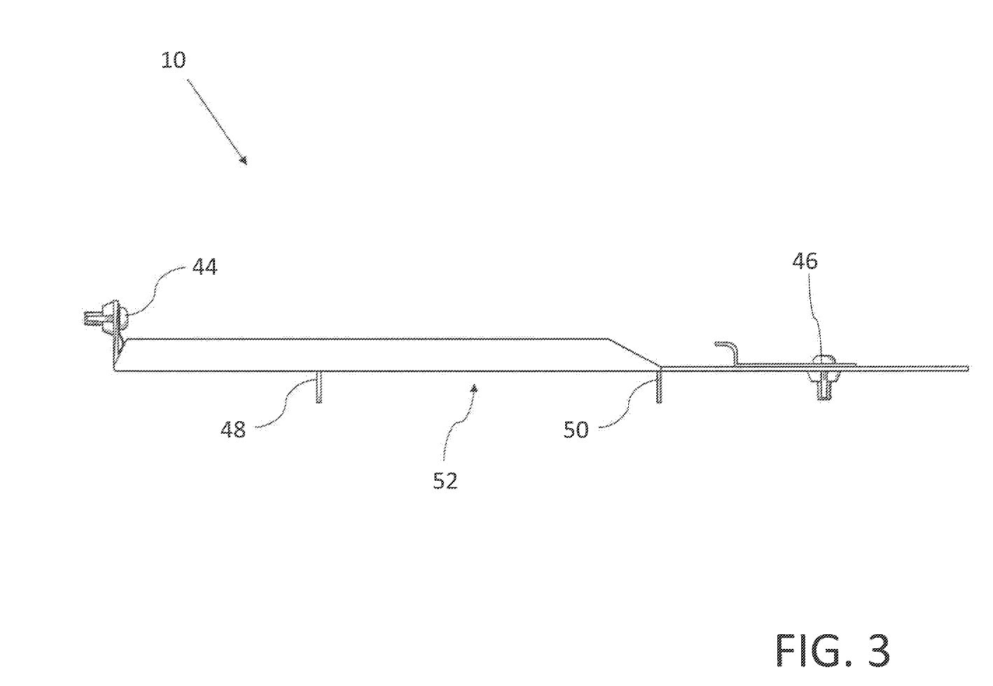

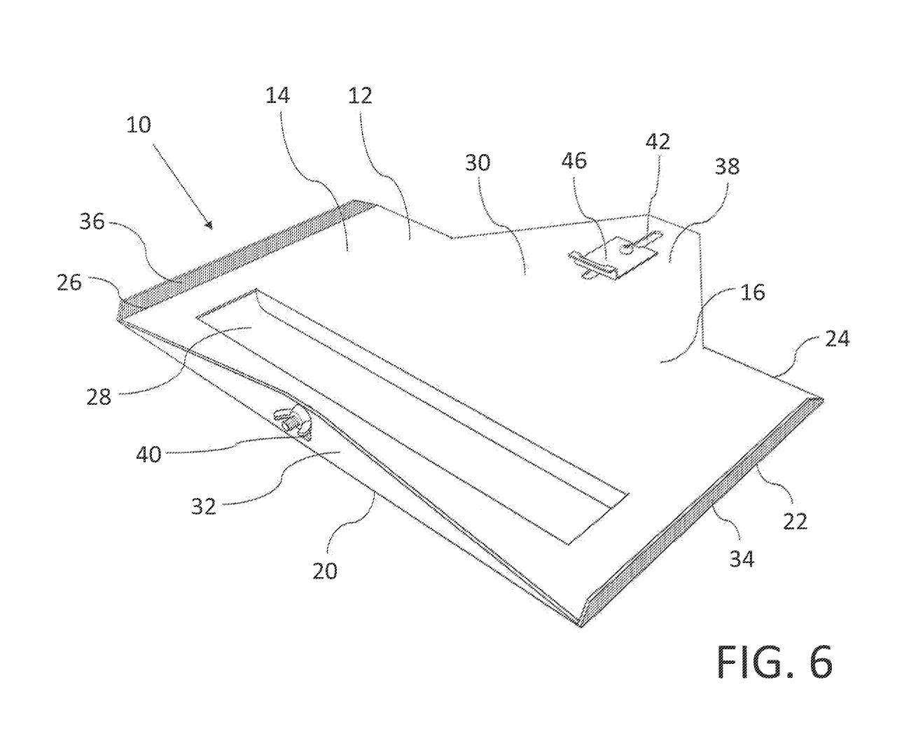

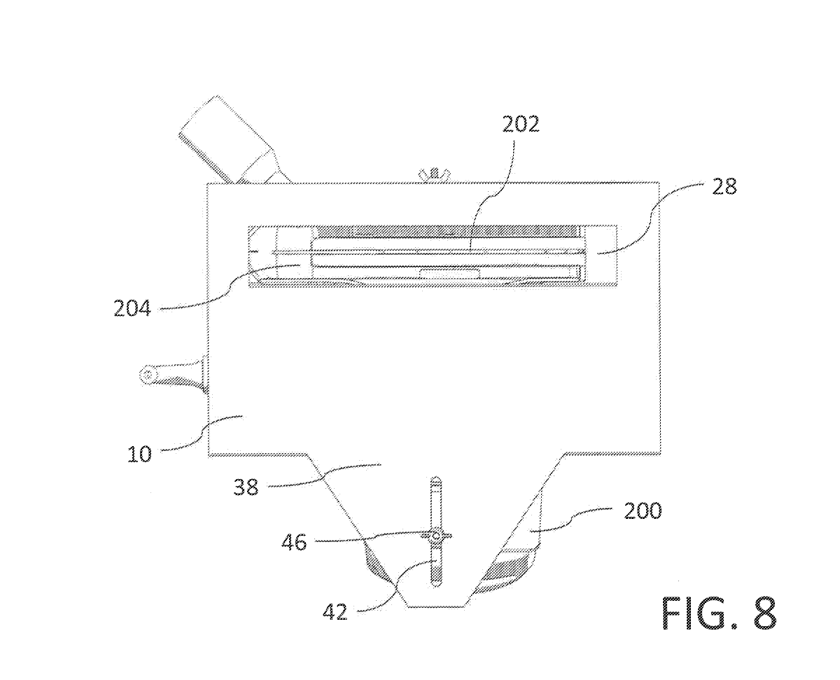

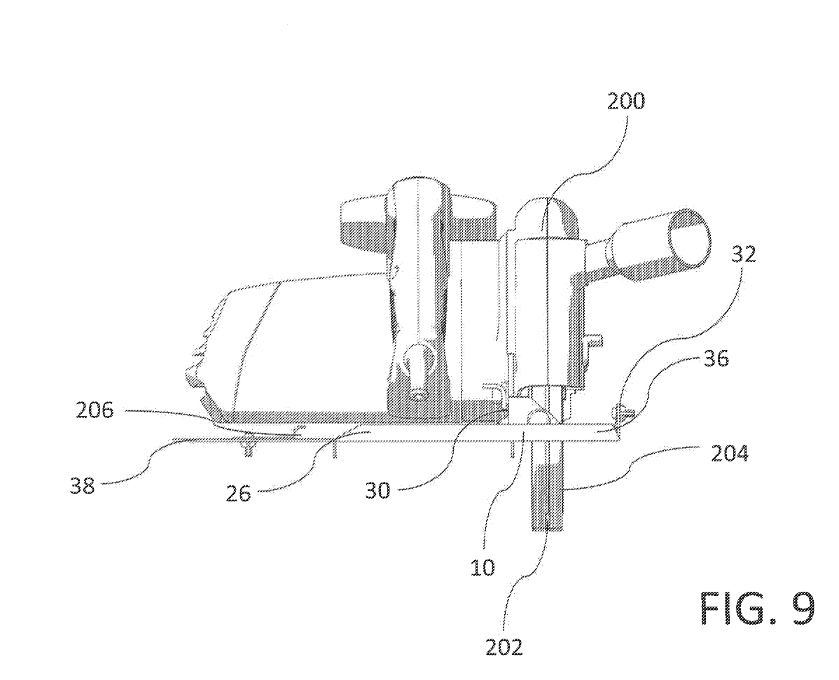

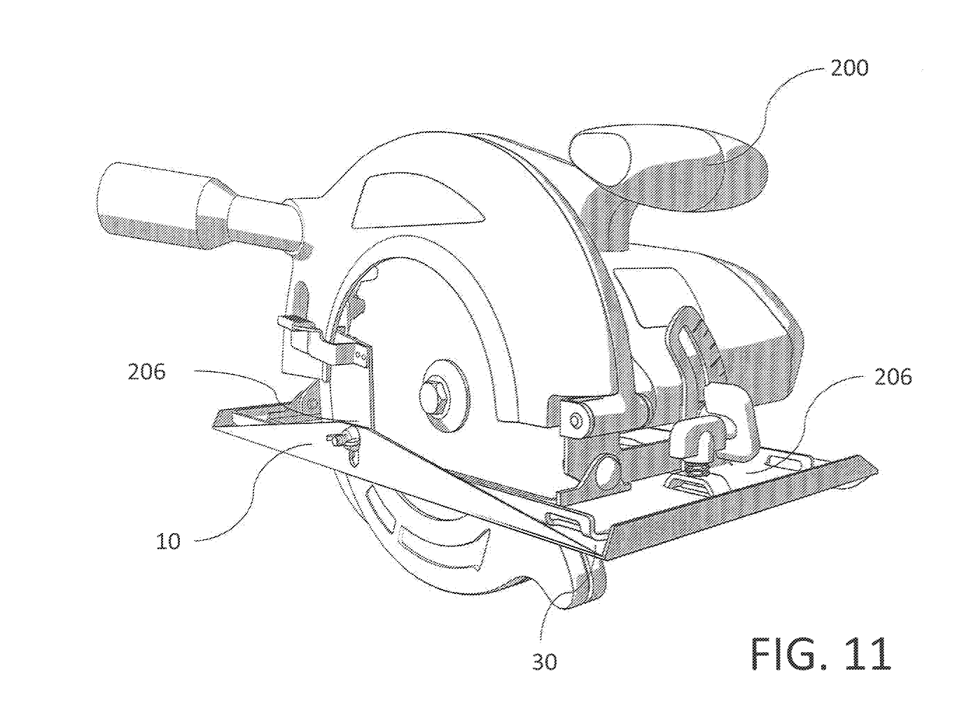

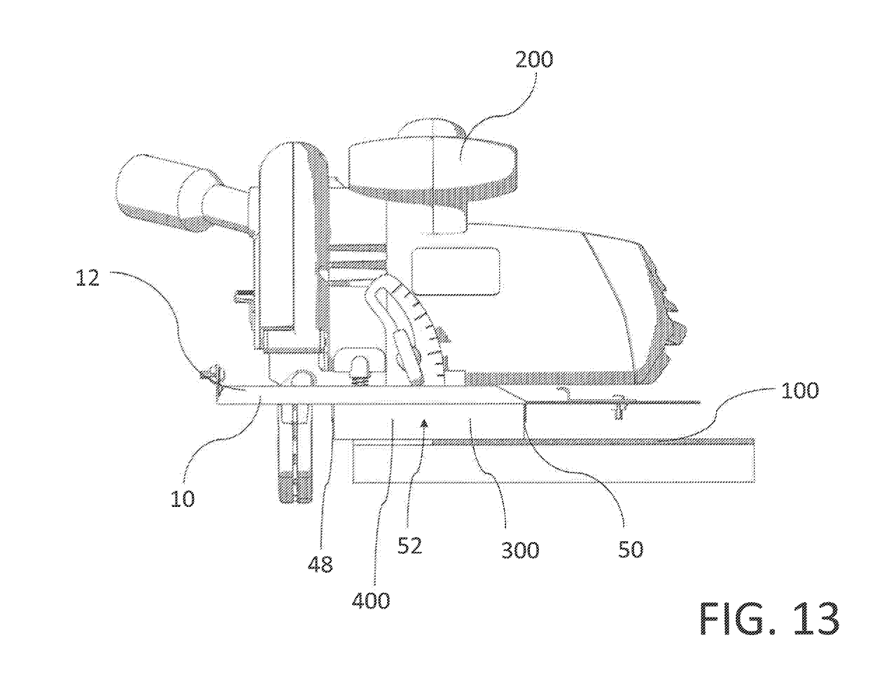

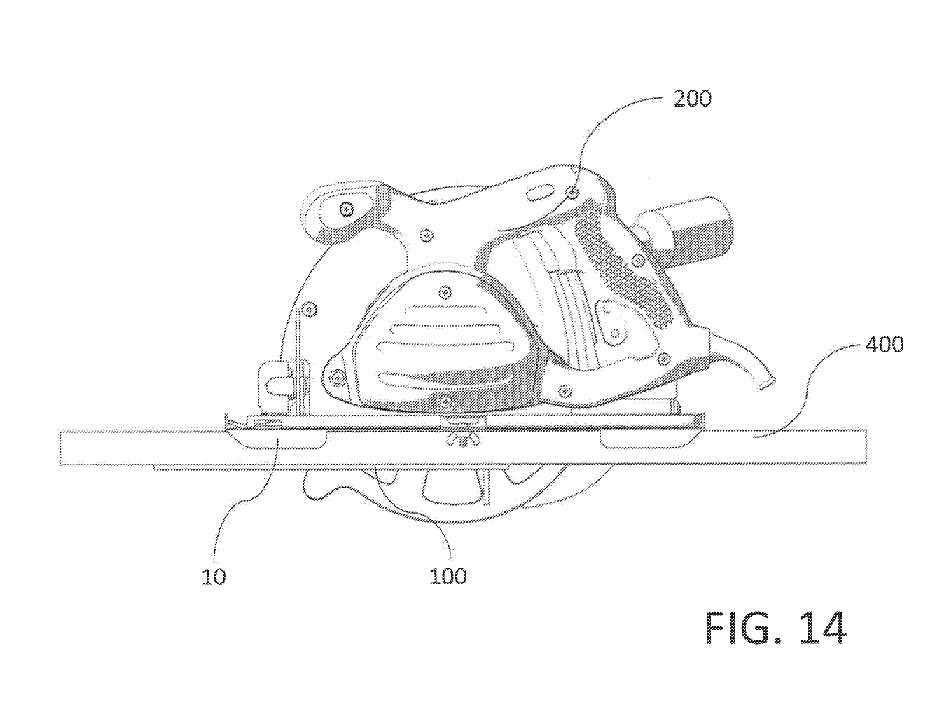

Referring to FIG. 11, there is illustrated saw guide 10 and a hand held power saw 200. Referring to FIG. 1 through FIG. 6 saw guide 10 has a guide body 12 in the form of a plate 14 having a first face 16 (top face) and a second face 18 (bottom face), peripheral edges 20, 22, 24, and 26. An elongated slot 28 is positioned adjacent to edge 20. Slot 28 extends through plate 14 from first face 16 to second face 18. Referring to FIG. 8, slot 28 is of a size selected to accommodate both a circular saw blade 202 saw blade guard 204 of power saw 200. Referring to FIG. 9, a saw receiving seat 30 is positioned on first face 14 which is adapted to receive hand held power saw 200 with rotating circular blade 202 of hand held power saw 200 extending down through slot 28, as shown in FIG. 8. Referring to FIG. 6, saw receiving seat 30 is bordered along peripheral edge 20 by upstanding tab 32, on peripheral edge 22 by upstanding border 34 and along peripheral edge 26 by upstanding border 36. Upstanding border 34 and upstanding border 36 serve to confine movement of shoe 206 of power saw 200 between peripheral edge 22 and peripheral edge 26 (FIG. 11). Upstanding tab 32 along peripheral edge 20 and a protruding tab 38 protruding outwardly from peripheral edge 24 serve as attachment tabs for securing power saw 200 to plate 14. Upstanding tab 32 and protruding tab 38 have slotted openings 40 and 42, respectively, to facilitate fasteners securing hand held power saw 200 on saw receiving seat 30. Referring to FIG. 3 through FIG. 5, there is illustrated a spring clip fastener 44 that is secured in a selected position along slotted opening 40 of upstanding tab 32. Referring to FIG. 1 and FIG. 2, there is illustrated a sliding clamp fastener 46 that is secured in a selected position along slotted opening 42 of protruding tab 38. Referring to FIG. 3, guides in the form of guide flanges 48 and 50 depend from second face 18 of plate 14. Guide flanges 48 and 50 define the boundaries of a guide channel, generally indicated by reference numeral 52, and form opposing sidewalls that are parallel to elongated slot 28 and parallel to each other. Referring to FIG. 13 and FIG. 14, when in use a rail 300 is secured to a substrate being cut by power saw 200 and then saw guide 10 is placed over rail 300 with rail 300 positioned within guide channel 52. Rail 300 may be formed using any material that is known in the art that can be used to provide a straight rail that is sized to fit within the guide channel 52 defined by the rail guides 48 and 50. For example, rail 300 may be a piece of wood that is sized to fit within guide channel 52. Guide body 12 travels axially along rail 300 with lateral movement of guide body 12 relative to rail 300 being constrained by guide flanges 48 and 50 which depend from second face 18 of plate 14 and define guide channel 52.

### Operation:

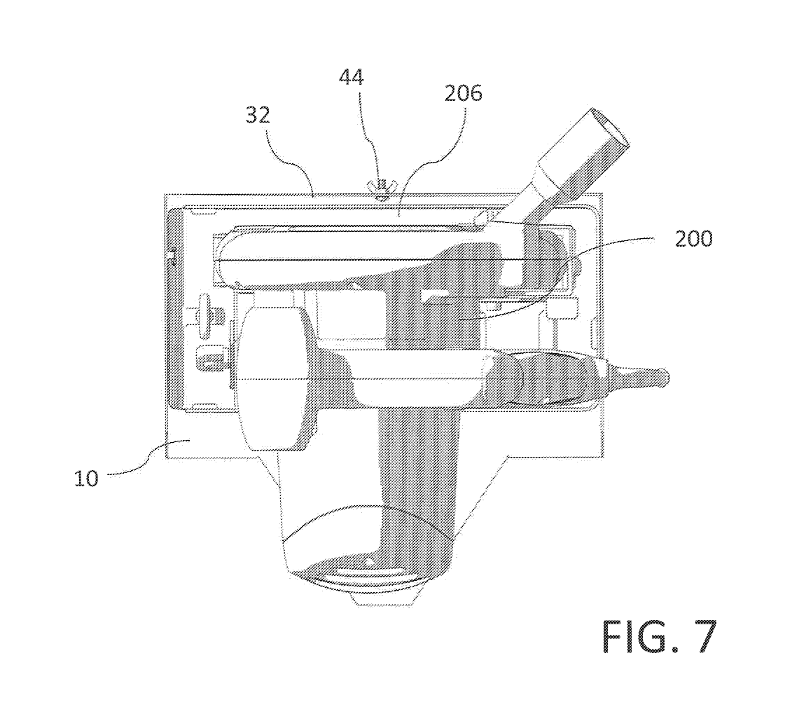

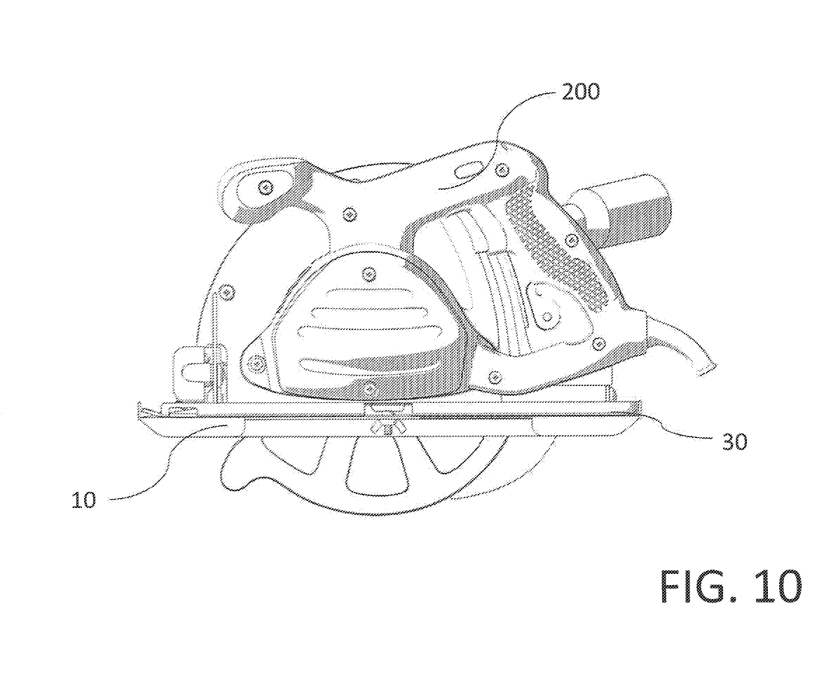

Referring to FIG. 10 and FIG. 11, in preparation for use, saw guide 10 is secured to power saw 200 with power saw 200 positioned on saw receiving seat 30. Referring to FIG. 7, spring clip fastener 44 on upstanding flange 32 (as illustrated in FIG. 3 and FIG. 5) is slid along slotted opening 40 to engage shoe 206 of power saw 200. Referring to FIG. 8 and FIG. 9, sliding clamp fastener 46 (as illustrated in FIG. 1 and FIG. 2) on protruding tab 38 is slid along slotted opening 42 to engage shoe 206 on the opposite side. Upstanding border 34 and upstanding border 36 serve to confine movement of shoe 206 of power saw 200 between peripheral edge 22 and peripheral edge 26. Upstanding tab 32 along peripheral edge 20 and a protruding tab 38 protruding outwardly from peripheral edge 24 serve as attachment tabs for securing power saw 200 to plate 14. Referring to FIG. 13, rail 300 is secured to the substrate being cut by power saw 200 and then saw guide 10 is placed over rail 300 with rail 300 positioned within guide channel 52 (guide channel 52 being best illustrated in FIG. 3). Guide body 12 travels axially along rail 300 with lateral or twisting movement of guide body 12 relative to rail 300 being constrained by guide flanges 48 and 50 Which depend from second face 18 of plate 14 and define guide channel 52.

### Variations

It will be appreciated that other forms of fasteners may be used to secure power saw 200 to saw receiving seat 30.

### Complementary Rail Positioning Guide

The manner of securing rail 300 to a substrate being cut by power saw 200 has not been described in detail, as this would be well known to a person skilled in the art. There are various clamps that can be used to clamp rail 300 in position on the substrate. However, problems can be encountered when trying to position rail 300 for angular cuts. There will now be described rail positioning guide 100 with reference to FIG. 12 through 16. Rail positioning guide 100 was developed for use with saw guide 10.

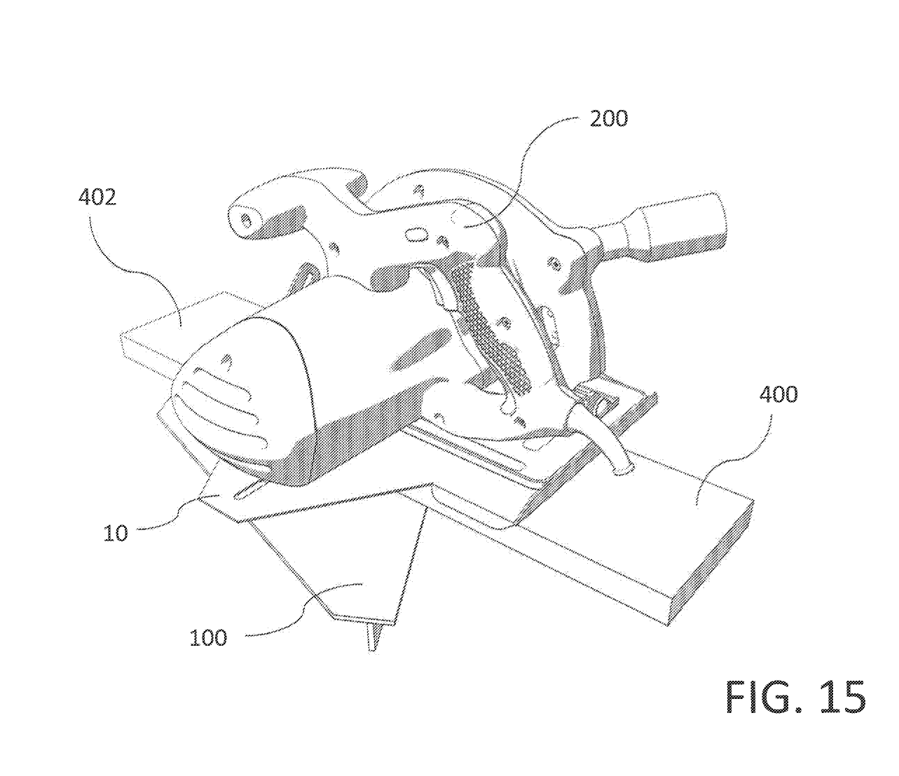

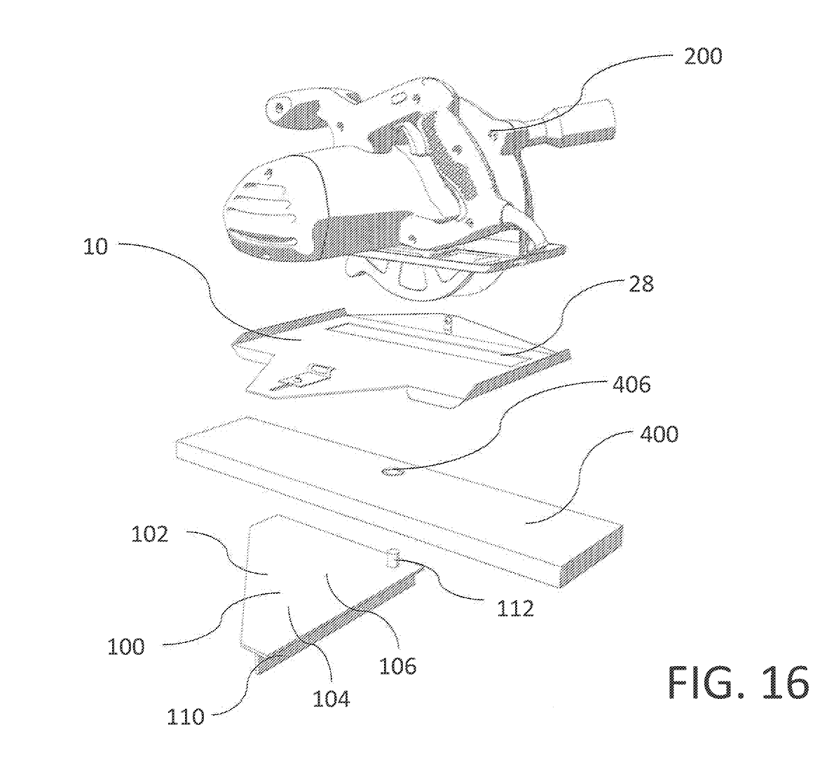

Referring to FIG. 16, rail positioning guide 100 has a body 102 in the form of a plate 104 having an upper surface 106 and a lower surface 108 (seen in FIG. 12). A flange 110 is used to hold plate 104 against a substrate to be cut by power saw 200. Body 102 has an upstanding axle 112. Referring to FIG. 15, a modified rail 400 is used with rail positioning guide 100. Modified rail 400 has a top surface 402 and a bottom surface 404 (seen in FIG. 12). In the illustrated embodiment, an axle receiving opening 406 (seen in FIG. 16) is provided that extends completely through rail 400 from bottom surface 404 to top surface 402. It will be appreciated that axle receiving opening 406 in bottom surface 404 need not extend completely through rail 400. Once positioned on upstanding axle 112, rail 400 may be pivoted about upstanding axle 112 to a selected pivotal position which provides guidance for an intended angular cut. Rail 400 is then secured to the substrate in the selected pivotal position by clamps. Referring to FIG. 15, saw guide 10 is then placed upon rail 400 and functions as described above.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A saw guide for a hand held power saw with a rotating circular blade, comprising:
a guide body in the form of a plate having a first face and a second face, peripheral edges and an elongated slot positioned adjacent one of the peripheral edges, the slot extending through the plate from the first face to the second face;
a saw receiving seat on the first face adapted to receive the hand held power saw with the rotating circular blade of the hand held power saw extending down through the elongated slot;
protruding attachment tabs along the peripheral edges of the plate having openings to facilitate fasteners securing the hand held power saw on the saw receiving seat; and
guides depending from the second face of the plate, the guides defining a guide channel with opposing sidewalls that are parallel to the elongated slot and parallel to each other.

2. The saw guide of claim 1 in combination with a rail positionable within the guide channel, the guide body travelling axially along the rail with lateral movement of the guide body constrained by the guides that depend from the second face of the plate and define the guide channel.

3. The saw guide of claim 2, wherein the rail is sized to fit within the guide channel.

4. The saw guide of claim 1 in combination with a rail positioning body, comprising a plate having an upper surface and a lower surface, means for attaching the plate to a substrate being cut by a saw, and an upstanding axle, the rail having a top surface and a bottom surface, with an axle receiving opening in the bottom surface, such that the rail pivots about the axle to assume a selected pivotal position in preparation for making an angular cut.

5. A combination, comprising:
a rail positioning guide having an upstanding axle;
a rail haying a bottom surface with an axle receiving opening, the upstanding axle being receiving in the axle receiving opening to facilitate the rail pivoting to a selected pivotal position in preparation for making an angular cut; and
a saw guide having a guide body with depending guides defining a guide channel into which the rail is received and which restricts lateral or twisting movement of the saw guide as the saw guide is moved axially along the rail.

6. The combination of claim 5, wherein the rail is sized to fit within the guide channel.
